(19) United States
(12) Patent Application Publication
(10) Pub. No.: US 2016/0042213 A1
(43) Pub. Date: Feb. 11, 2016

(54) RFID User Input Device with One or More Integrated Circuits for Use with an RFID System

(71) Applicant: GEMA TOUCH, INC., Cary, NC (US)

(72) Inventors: Brent Ray Fagg, Cary, NC (US); Joanna Rogerson, Cary, NC (US); Thomas Craig Weakley, Simpsonville, SC (US)

(21) Appl. No.: 14/378,737

(22) PCT Filed: Feb. 14, 2013
(86) PCT No.: PCT/US13/26053

§ 371 Date: Aug. 14, 2014

Related U.S. Application Data
(60) Provisional application No. 61/697,887, filed on Sep. 7, 2012.
(60) Provisional application No. 61/598,949, filed on Feb. 15, 2012.

(51) Int. Cl. G06K 7/10

(52) U.S. Cl. CPC G06K 7/10366

(57) ABSTRACT

A RFID system that includes a RFID user input device and an RFID-enabled device. The user input device is configured to send one or more commands to control the enabled device. The user input device may include an antenna pattern operatively connected to one or more separate integrated circuits. The user input device may further include an input component associated with each integrated circuit. The input components may be activated causing information stored at the associated integrated circuit to be sent to the enabled device. The enabled device may be configured to act upon the information in a desired manner.

### RELATED APPLICATIONS

The present application claims priority to U.S. application Ser. No. 61/598,949 filed on Feb. 15, 2012, and entitled “RFID User Input Device”, and U.S. application Ser. No. 61/697,887 filed on Sep. 7, 2012, and entitled “RFID User Input Device with Multiple Integrated Circuits”, each of which is herein incorporated by reference in its entirety.

### BACKGROUND

Radio-Frequency IDentification (RFID) includes the use of radio-frequency electromagnetic fields to transfer data from a first device to a second device. Electrical power may be generated in an antenna pattern in the first device through inductive coupling with an RFID reader in the second or third device. Inductive coupling is a term used to describe when two conductors are configured such that a change in current flow through one wire induces a voltage across the ends of the other wire through electromagnetic induction. Information in the first device may then be transmitted for use by the second device.

RFID technology may be used in many different industries and in many different applications. Applications include but are not limited to tracking the location of an asset, track parts and work in process in various manufacturing settings, and in various types of payments systems.

There is a need to improve the use of RFID technology system for applications for user interaction with an RFID input device.

### SUMMARY

The present application is directed to an RFID input device with one or more integrated circuits for use with an RFID system. The user input device is configured to send one or more commands to control the enabled device. The user input device may include an antenna pattern operatively connected to one or more separate integrated circuits. The user input device may further include an input component associated with each integrated circuit. The input components may be activated causing information stored at the associated integrated circuit to be sent to an RFID enabled device. The enabled device may be configured to act upon the information in a desired manner.

One embodiment is directed to a method of operating an application running on an RFID enabled device based on information received from an RFID input device. The method includes inductively coupling an antenna pattern of the RFID input device with an RFID reader, and receiving information at the RFID enabled device from an active input component of the RFID input device while the RFID input device is inductively coupled with the RFID reader. The method also includes recognizing the RFID input device at the RFID enabled device, determining a command corresponding to the received information, and operating the application running on the RFID enabled device based on the command.

In this method, the RFID reader may be incorporated with the RFID enabled device.

The step of determining the command corresponding to the received information and operating the application running on the RFID enabled device based on the command may be performed in various manners. This step may include determining that the signal is intended for the application running on the RFID enabled device. The step may include determining that the information is not intended for the application running on the RFID enabled device but can be interpreted by the application running on the RFID enabled device. The step may include determining that the information is not intended for or can be interpreted by the application running on the RFID enabled device and determining that the information can be interpreted by another application on the RFID enabled device. The step may also include determining that the information is not intended for or can be interpreted by the application running on the RFID enabled device and accessing an input device menu to interpret the information.

The input device menu may include previously used applications that may be able to recognize the information.

Another embodiment is directed to a method of operating an RFID enabled device based on information received from an RFID input device. The method includes inductively coupling an antenna pattern of the RFID input device with an RFID reader and receiving information at the RFID enabled device from an active input component of the RFID input device while the RFID input device is inductively coupled with the RFID reader. The method also includes determining that the RFID input device is not recognized at the RFID enabled device, determining that the information includes a recognition method of recognizing the RFID input device, and using the recognition method to recognize the input device.

The step of determining that the information includes the recognition method of recognizing the RFID input device and using the recognition method to recognize the input device may include accessing an application for a web address included in the information to recognize the RFID input device.

The step of determining that the information includes the recognition method of recognizing the RFID input device and using the recognition method to recognize the input device may include opening an application stored on the RFID enabled device based on instructions included in the information.

The RFID reader may be incorporated with the RFID enabled device.

Another embodiment is directed to an RFID system that includes a user input device with at least one antenna pattern, a plurality of breaks positioned along the one or more antenna patterns with each of the breaks including a gap formed between discontinuous sections of one of the at least one antenna pattern, a plurality of integrated circuits each configured with information that is transmitted when the associated integrated circuit is powered with each of the integrated circuits being associated with a different one of the breaks, and a plurality of keys with each being associated with a different one of the breaks with each of the keys including a conductive material configured to extend across the gap formed between the discontinuous sections of the associated one of the breaks. The RFID system also includes an RFID reader configured to inductively couple with the RFID input device responsive to user activation of at least one of the plurality of keys, and an RFID enabled device configured to receive the information from the user input device when the RFID input device is inductively coupled with the RFID reader. The RFID enabled device is configured to execute corresponding commands in an application operating on the RFID enabled device.

The RFID reader may be incorporated with the RFID enabled device.

Each of the integrated circuits may be associated with a different one of the antenna patterns.

The RFID input device may include a stacked configuration with a partition layer that includes one or more keyholes positioned between a first layer that includes the at least one antenna pattern and a third layer that includes the plurality of keys.

The user input device may include a plurality of input sets each configured to send a different one of the information to the RFID enabled device with each of the input sets including one of the breaks, one of the keyholes, and one of the keys.

Third layer may include a flexible substrate that supports the plurality of keys with the flexible substrate being deformable to bring one of the plurality of keys into contact with the corresponding one of the breaks.

The RFID enabled device may be configured to recognize the RFID input device based on the information received from the RFID input device.

The RFID enabled device may be configured to determine that the RFID input device is not recognized at the RFID enabled device, determine that the information includes a method of recognizing the RFID input device, and use the method included with the information and recognizing the input device.

Another embodiment is directed to an RFID system that includes a user input device. The user input device includes an antenna pattern, a break positioned along the antenna pattern and including a gap formed between opposing exposed ends, and an integrated circuit associated with the break and configured with information that is transmitted when the integrated circuit is powered. The RFID system includes an RFID reader configured to inductively couple with the RFID input device responsive to user activation of the integrated circuit, and an RFID enabled device configured to receive the information from the integrated circuit when the RFID input device is inductively coupled with the RFID reader. The RFID enabled device is configured to execute a corresponding command in an application operating on the RFID enabled device.

The input device may include a key associated with the breaks and including a conductive material configured to extend across the gap formed between the discontinuous section of the break.

The various aspects of the various embodiments may be used alone or in any combination, as is desired.

### BRIEF DESCRIPTION OF THE DRAWINGS

FIG. 1 is a schematic view of an RFID input device, an RFID reader, and an RFID enabled device.

FIG. 2 is an exploded schematic view of an RFID input device that includes an RFID tag layer, a partition layer, and a key pad layer.

FIG. 3 is a schematic side view of an RFID input device.

FIG. 4A is a schematic side view of an RFID input device in an inactive state.

FIG. 4B is a schematic side view of an RFID input device in an active state.

FIG. 5 is an exploded schematic view of an RFID input device that includes an RFID tag layer, a partition layer, and a key pad layer.

FIG. 6 is an exploded schematic view of an RFID input device that includes an RFID tag layer, a partition layer, and a key pad layer.

FIG. 7 is a top view of an input device and an RFID enabled device.

FIG. 8 is a top view of an input device and an RFID enabled device.

FIG. 9 is a top view of a portion of an RFID input device.

FIG. 10 is a schematic view of an RFID enabled device with an incorporated RFID reader.

FIG. 11 is a graph indicating three separate RFID input devices with different tuning frequencies.

FIG. 12 is a flowchart diagram of a process of using an RFID input device.

FIG. 13 is a flowchart diagram of a process of using an RFID input device

### DETAILED DESCRIPTION

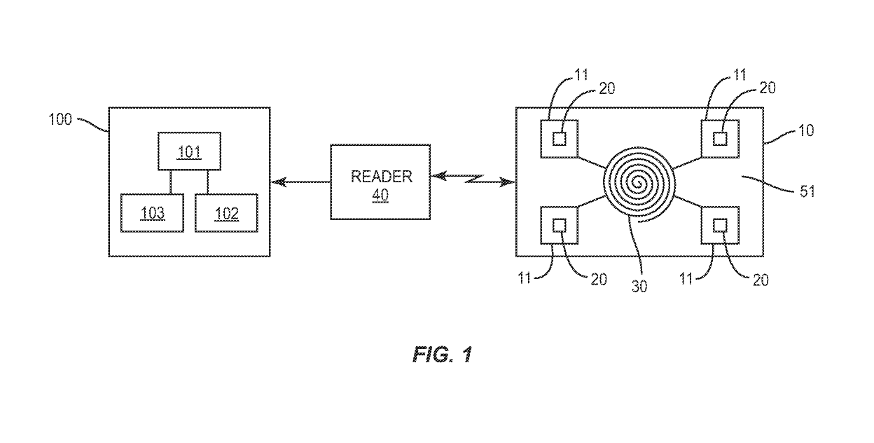

FIG. 1 schematically illustrates an RFID (Radio Frequency IDentification) user input device 10 configured to send multiple different commands to control an RFID-enabled device 100. The RFID input device 10 includes an antenna pattern 30 operatively connected to two or more separate integrated circuits 20 (hereinafter IC 20). The device 10 further includes input components 11 associated with each IC 20. The input components 11 may be activated causing information stored at the associated IC 20 to be sent through an RFID reader 40 to the device 100. The device 100 is configured to act upon the information in a desired manner.

In use, electrical power is generated in the antenna pattern 30 through inductive coupling with the RFID reader 40. Inductive coupling is a term used to describe when two conductors are configured such that a change in current flow through one wire induces a voltage across the ends of the other wire through electromagnetic induction. In an inactive state (i.e., a user has not selected a desired input), the various input components 11 corresponding to the various ICs 20 are open thus resulting in no information being signaled to the device 100. In an active state, the user activates one of the input components 11 to select a desired input. This activation causes a closed electrical circuit between the antenna pattern 30 and the corresponding IC 20. The input component 11 may be configured to provide an indication to the user of the activation. The input component 11 may provide tactile and/or audible feedback to the user indicating the change in state. Examples include but are not limited to mechanical structures such as dome, toggle, and push-button switches. Other examples include one or more actuators that provide haptic feedback or vibratory confirmation.

The electrical power generated in the antenna pattern 30 is transferred to the IC 20 causing the IC 20 to generate and transfer the information to the antenna pattern 30. The antenna pattern 30 then transmits the information to the RFID reader 40 through inductive coupling. The information is processed at the device 100 which performs the corresponding action.

This same process can be repeated using the other input components 11 on the RFID input device 10. The user selects the desired input and activates the corresponding input component 11 causing the information to be sent to the RFID reader 40 and device 100. During the process, the ICs 20 of the various non-selected inputs 11 are not powered and their corresponding signals are not sent to the device 100.

RFID input device 10 may include various numbers of ICs 20 and corresponding input components 11. Each IC 20 generally refers to a semiconductor wafer on which resistors, capacitors, and transistors are fabricated. The IC 20 is designed to process linear or digital input/output signals and function as an amplifier, timer, oscillator, counter, and computer memory.

Each IC 20 includes information that controls the device 100 when the corresponding input component 11 is activated by the user. The information may include various commands to operate a game or device (e.g., yes, no, enter, leave, right, left, up, down) or other commands associated a with conventional keyboard style user input device (e.g., a, b, c, 1, 2, 3). The information may also include directing the device 100 to open a URL code, or record a unique serial number assigned to input component 11.

One of the input components 11 corresponds with each of the ICs 20 and allows a user to move the IC 20 between the active and inactive states. The input components 11 may include a variety of different mechanical and electrical configurations to provide this functionality. In one embodiment, the input components 11 include a keying pattern that corresponds with breaks in the antenna pattern to activate the corresponding ICs 20.

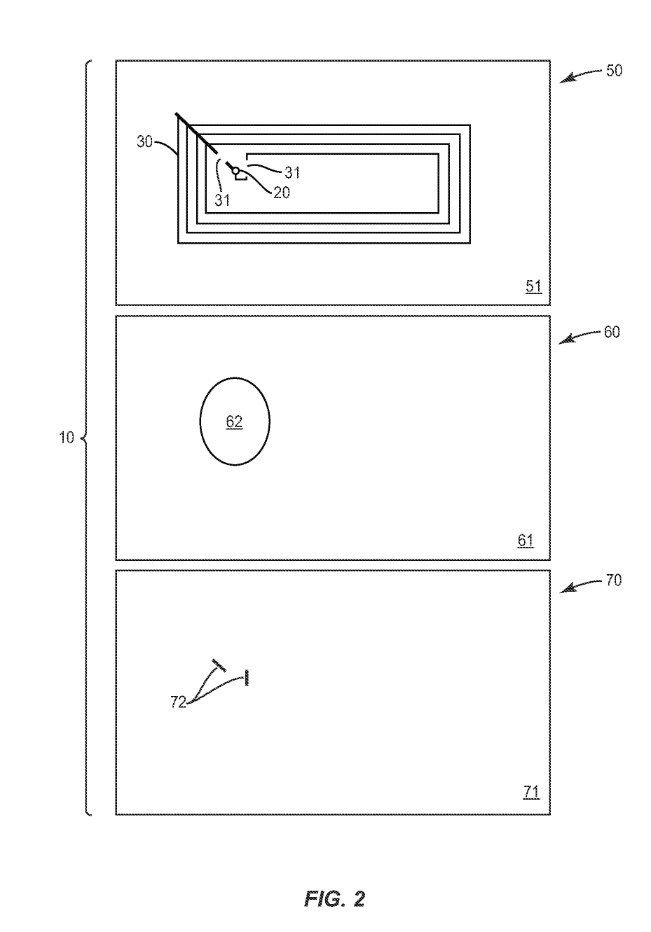

FIG. 2 illustrates an embodiment of an internal configuration of an input device 10. The input device 10 has three layers including an RFID tag layer 50, a partition layer 60, and a key pad layer 70. The input device 10 includes these three layers 50, 60, 70 being in a stacked configuration.

The RFID tag layer 50 includes a substrate 51 that supports the antenna pattern 30 and RFID components such as one or more ICs 20. The substrate 51 is a relatively thin member with a length and width greater than its thickness. The substrate 51 is flexible and is able to bend without breaking. The substrate 51 may be constructed from various materials, including but not limited to plastics produced in roll stock such as polypropylene, polyethylene terephthalate, polyethylene, polyvinyl chloride, and polystyrene. The substrate 51 may include a thickness of 40 mils or less.

The antenna pattern 30 may include a variety of configurations of a conductive material capable of generating a flow of current in the presence of a time-varying magnetic field, also known as electromagnetic inductance. For example, an antenna pattern 30 used in the RFID tag disclosed herein can include a circular coil with a single turn, multi turn multilayer circular coil, spiral coil, square loop coil with single or multilayer, and rectangular planar spiral. In certain embodiments, the antenna pattern 30 is constructed from a conductive material and can be arranged in any of a plurality of possible patterns so as to make possible inductive coupling. The operating frequency of the antenna pattern 30 may be based on the physical attributes of the antenna pattern 30, such as the number of coils, length and width of every coil segment, outside coil diameter, turn angles, material selection, etc. As used herein ‘conductive material’ refers to any material capable of conducting electricity. For example, the conductive material used for the antenna pattern 30 may include but is not limited to aluminum, copper, nickel, silver, gold and polyacetylene.

In the embodiment of FIG. 2, the antenna pattern 30 includes one or more breaks 31. The breaks 31 include an omitted section of the antenna pattern 30, and may be positioned at various locations on the antenna pattern 30.

The partition layer 60 is positioned adjacent to the RFID tag layer 50. The partition layer 60 includes a flexible layer 61 that extends across at least the antenna pattern 30. The layer 61 may be constructed from a flexible plastic film or other non-conductive material. One or more key holes 62 extend through the layer 61 and is sized to extend over the one or more breaks 31 in the antenna pattern 30.

The key pad layer 70 is adjacent to the partition layer 60 and away from the RFID tag layer 50. The key pad layer 70 includes a thin member 71 of flexible and/or thin material. An antenna key 72 is positioned on the member 71 and is configured to correspond to the one or more breaks 31 in the antenna pattern 30. The antenna key 72 is formed of a conductive material, and is typically constructed from the same material and produced in the same way as the antenna pattern 30. The antenna key 72 includes a configuration of conductive material that when connected to the antenna pattern 30 allows for the flow of electricity.

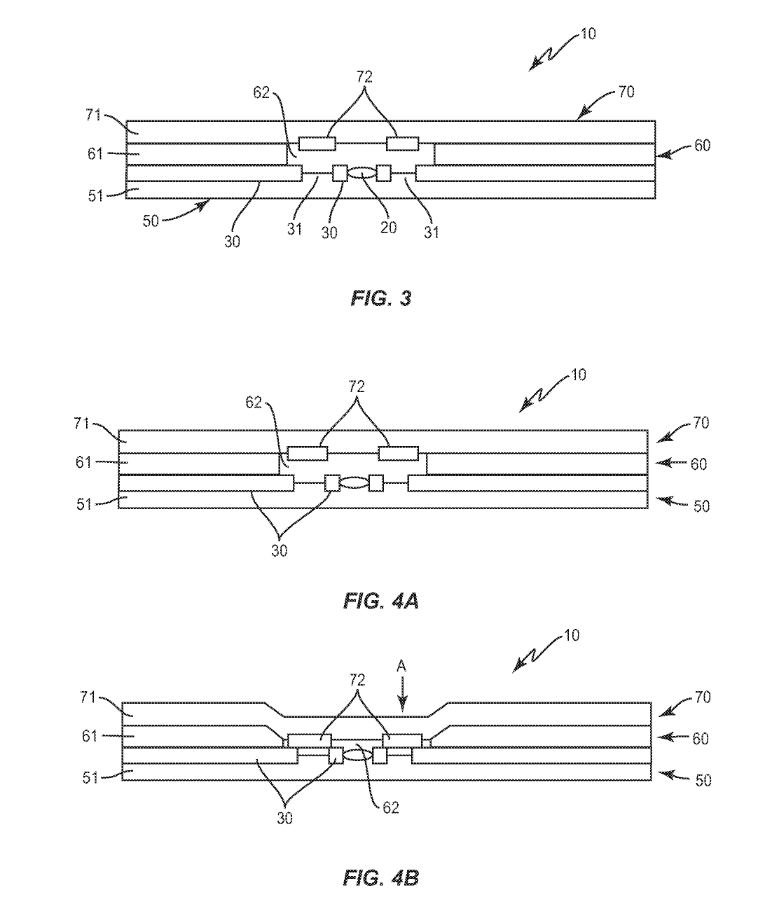

FIG. 3 illustrates the three layers 50, 60, 70 of the input device 10 in the stacked configuration. The partition layer 60 is positioned between the RFID layer 50 and the key pad layer 70. In this embodiment, the RFID tag layer 50 is the bottom layer and includes the antenna pattern 30 and IC 20 located on a top side of the substrate 51. The partition layer 60 is the middle layer of input device 10 and is positioned with the key hole 62 extending over the breaks 31. The key pad layer 70 is the top layer and includes the antenna key 72 located on the bottom side of the member 71.

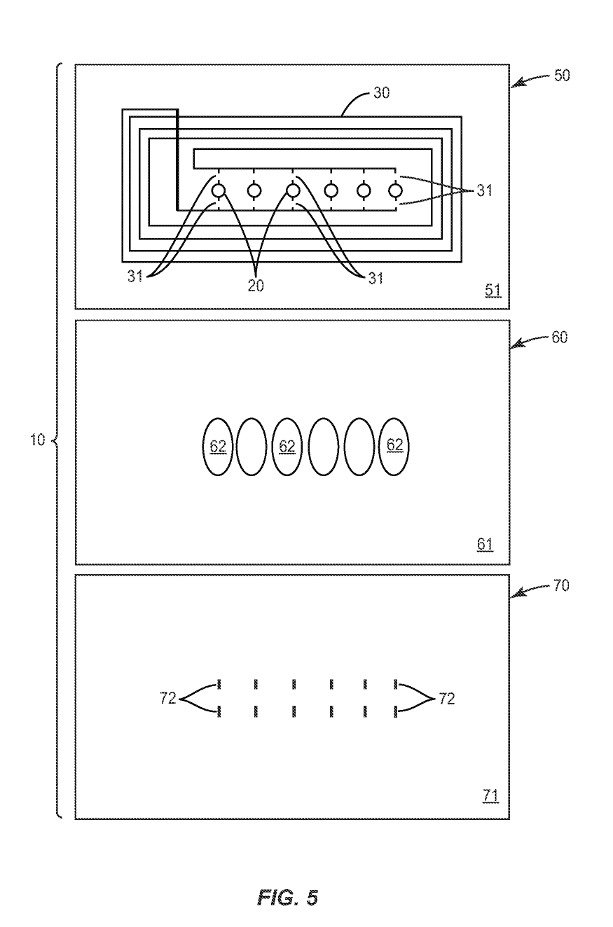

FIG. 4A illustrates the input device 10 in an inactive state. In this state, the partition layer 60 spaces apart the RFID tag layer 50 and the key pad layer 70. Specifically, the antenna key 72 is spaced apart from the antenna pattern 30.

FIG. 4B illustrates the input device 10 in an active state caused by a downward force A being applied to the top of the key pad layer 70. This force causes the flexible member 71 of the key pad layer 70 to move through the key hole 62 in the partition layer 60 and to contact the antenna key 72 with the break 31 in the antenna pattern 30. The signal generated by the IC 20 can be preprogrammed. Applications of the input device 10 may include directing the RFID enabled device 100 to open a URL code, record unique serial number assigned to the input device 10 or other commands associated a with conventional keyboard style user input device, for example a, b, c, 1, 2, 3, etc.

In the active state, the antenna pattern 30 and the antenna key 72 are connected so as to allow a closed electrical circuit with the IC 20. As used herein, the term “active state” refers to a closed circuit wherein there is a complete path between the positive and negative terminals of the power source.

In the active state, the input device 10 receives power and information from a suitable source, such as the reader 40, through the antenna pattern 30. The electrical power generated in the antenna pattern 30 transfers to the IC 20. When powered, the IC 20 generates a signal and transfers the signal to the antenna pattern 30. The antenna pattern 30 transmits the signal from the IC 20 to an RFID enabled device 100 through inductive coupling.

When the force A is removed from the key pad layer 70, the layer 70 returns towards its original position and returns the input device 10 to the inactive state. In the inactive state, the electrical circuit described above is not intact. The antenna pattern 30 and the antenna key 72 are not connected thereby preventing inductive coupling with an RFID enabled device. The inactive state refers to an open circuit where there is a not complete path between the positive and negative terminals of the power source.

FIG. 5 illustrates another embodiment of an input device 10 that includes multiple ICs 20 and a single antenna pattern 30. The input device 10 again has three layers including the RFID tag layer 50, partition layer 60, and key pad layer 70. In use, the layers 50, 60, 70 are aligned in a stacked configuration with the partition layer 60 positioned between the RFID tag layer 50 and the key pad layer 70.

The RFID tag layer 50 includes multiple ICs 20 associated with the antenna pattern 30. Further, breaks 31 are positioned within the antenna pattern 30 at each of the ICs 20. The partition layer 60 includes the member 61 and multiple key holes 62. The key holes 62 are sized and positioned to be aligned with the breaks 31 when the partition layer 60 is placed over the RFID tag layer 50. The key pad layer 70 includes multiple keys 72 positioned on the member 71. Each of the keys 72 aligns with a corresponding key hole 62 and break 31 when the layer 70 is aligned with the other layers 50, 60.

FIG. 5 includes each of the breaks 31 and each of the keys 72 being substantially the same. Other embodiments with multiple ICs 20 may include the various breaks 31 and keys 72 including different shapes, sizes, or configurations.

In use, each of the keys 72 and ICs 20 corresponds to a different input option for a user. The user is able to apply a force to the input component 11 indicated on the key pad layer 70 at the corresponding key 72 to contact the key 72 with the corresponding break 31 at the IC 20. This causes a particular signal to be sent from the input device 10 to the corresponding RFID enable device 100. In one embodiment, indicia are positioned at each of the keys 72 to indicate to the user the options for entering the various inputs. By way of example, each key 72 may correspond to a different number or a different letter of the alphabet. The numbers or letters appear at the keys 72 to assist the user in entering the proper input.

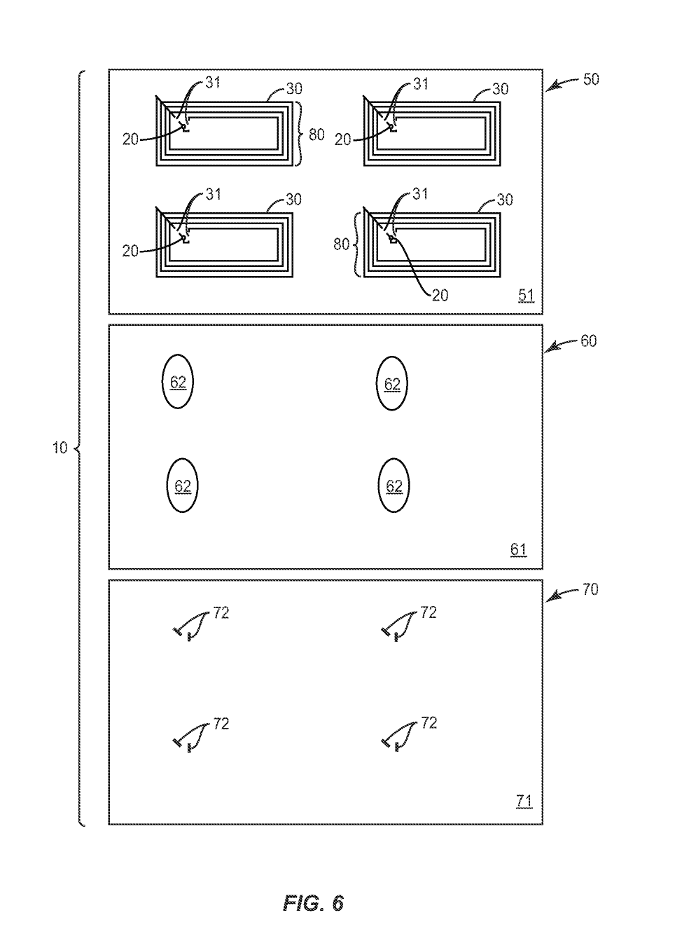

FIG. 6 illustrates another embodiment of an input device 10. This embodiment includes the RFID tag layer 50 having multiple RFID component sets 80. Each of the sets 60 includes an antenna pattern 30 with a break 31 and an IC 20. FIG. 6 includes each of the sets 60 being substantially the same. Other embodiments may include the different sets 60 having one or more different antenna patterns 30, breaks 31, and ICs 20, and number of ICs 20. In some embodiments, one or more of the sets 60 may not include an antenna break 31.

The input device 10 further includes the partition layer 60 having a member 61 with key holes 62 that align with the breaks 31 in the antenna patterns 30. Further, the key pad layer 70 includes keys 72 that align with the key holes 62 and breaks 31.

In use, the applicable portion of the key pad layer 70 may be pressed by the user to contact the corresponding key 64 through the aligned key hole 62 and across the break 31 and against the corresponding antenna pattern 30. The input device 10 with multiple RFID component sets 80 provides the capabilities to generate multiple signals for a variety of different applications. In one embodiment, one or more RFID component sets 80 contain an antenna pattern 30 without an antenna break 31. The antenna pattern 30 without a break 31 would contain a complete circuit and function continuously in an active state. Additional RFID component sets 80 would provide for specific inputs as described above.

Another embodiment utilizes the user's finger as a key instead of using a conductive material (as illustrated in FIGS. 2, 5, and 6). The user's finger replaces the key to extend across the applicable break 31. The break 31 is sized such that the user's finger can span the omitted section and complete the antenna pattern 30 to provide for the flow of electricity to power the IC 20. In one embodiment, a substrate layer is positioned over the antenna pattern and is directly contacted by the user (i.e., the user does not directly contact the antenna pattern). This layer may include indicia to indicate the location where the user should apply the force to power the corresponding IC. In another embodiment, the user directly contacts the antenna pattern.

The various embodiments with multiple ICs 20 provides the capabilities to generate multiple signals, each unique to a specific IC 20. In one embodiment, when pressure is applied to one of the keys 72 in the key pad layer 70, the key 72 makes contact with the corresponding antenna pattern 30 thereby completing the circuit for inductive coupling. Power will be provided to the corresponding IC 20 and thereby generate a unique signal. The unique signal will initiate a specific command in the RFID enabled device 100. For example, a plurality of ICs 20 could direct the user to a plurality of URLs, or the unique signal could represent commands typical of a conventional user input keyboard such as a, b, c, 1, 2, 3, etc.

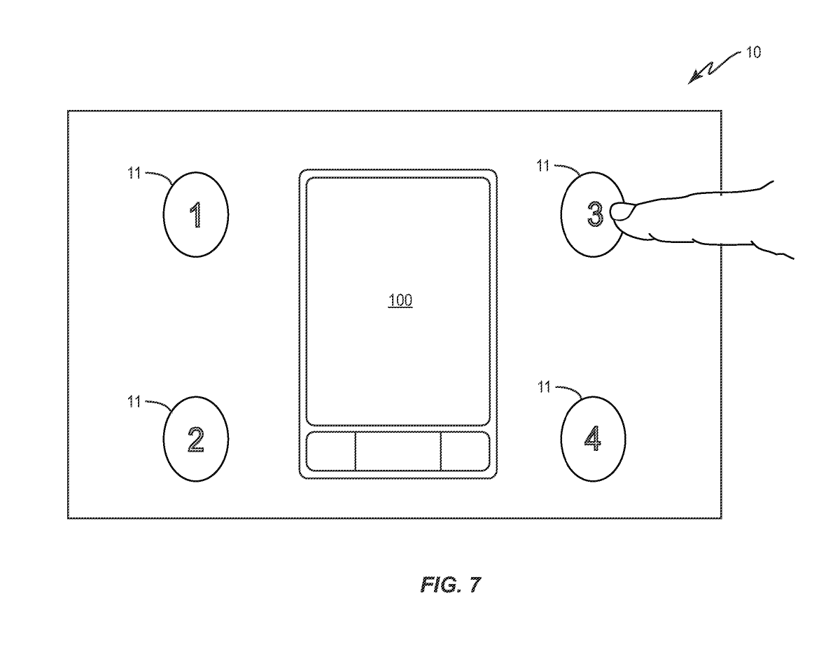

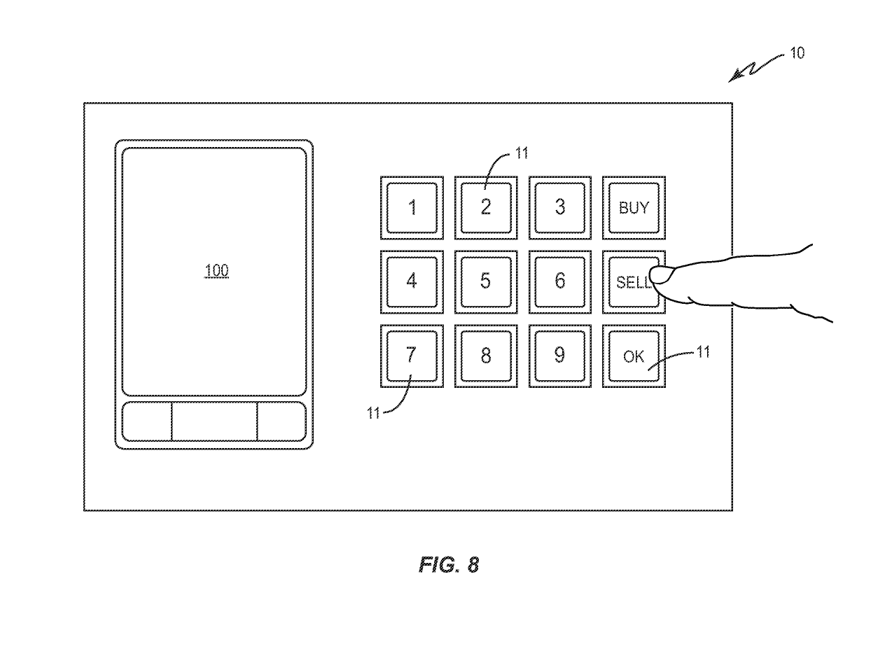

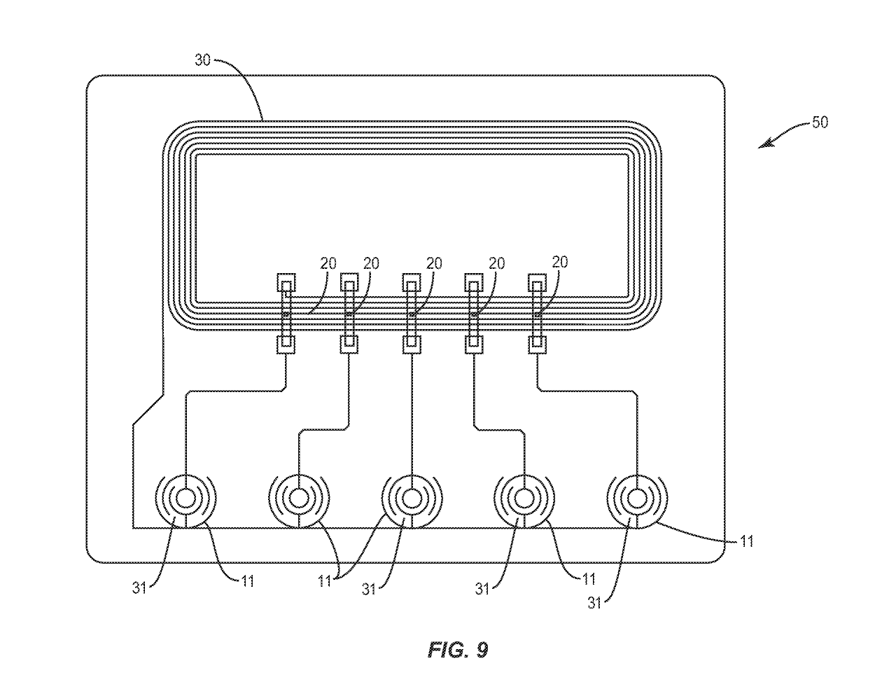

The input devices 10 may include a variety of different appearances and include a variety of different input options. FIGS. 7 and 8 illustrate different embodiments. Each of the input devices 10 include input components 11 for a user to enter a desired input. In these embodiments, the input components 11 are buttons that each corresponds to a different key 72 and corresponding break 31 in an antenna pattern 30 to power an IC 20. The various indicia indicating the input components 11 may appear on the key pad layer 70. Alternatively, an additional layer is placed over the key pad layer 70 and includes the various indicia that align with the keys 72 on the key pad layer 70. In these embodiments, an RFID enabled device 100 is included for representational purposes but is not part of the subject invention.

In use, a user applies pressure to an input component 11. This causes the corresponding key 72 to span the break 31 and contact the antenna pattern 30. This in turn activates the associated IC 20 which transmits a programmed set of information to the RFID enabled device 100.

Each input component 11 may result in a different set of instructions or data. Programmed information could include unique instructions, web address, alpha-numeric information, directional information such as up, down, left, right. Typically the IC 20 will be programmed with instructions or data associated with indicia on the input component 11. For example, pressing a first input component 11 with indicia of “1” will cause the input device 10 to transmit a “1” data signal to the RFID enabled device 100. Likewise, an input component 11 with indicia “sell” will cause the device 10 to transmit a “sell” data signal. How the RFID enabled device 100 processes and interprets the received signal is dependent on software operating on the RFID enabled device 100 and can change depending on what software applications are actively in use. For example, using a traditional keyboard, word processing software, may interpret pressing “1” as a command it insert “1” at the current location in a document. But, using the same traditional keyboard, inventory management software may interpret pressing “1” as a command to open an inventory menu designated as “1”. Therefore, the input device 10 can be used to enter various inputs for use in a plurality of applications.

Another embodiment is illustrated in FIG. 9. The input components 11 include enlarged input areas having a substantially circular shape. The input components 11 form a portion of the antenna pattern 30. The antenna pattern 30 further includes intermediate sections that extend outward from a main portion to each of the input components 11. The input components 11 further include one or more breaks 31. When a user provides the necessary input, the break of the corresponding input section is closed thereby providing for the corresponding IC 20 to be powered. The break 31 may be connected by a key 72 positioned in a different layer as illustrated in FIGS. 5 and 6. Alternatively, the user's finger itself acts as the key to complete the connection as described above. The input components 11 will further include indicia (not illustrated) that identify and differentiate the different inputs. In use, a user will contact the area of the component 11, causing the corresponding IC 30 to be powered to communicate with the RFID enabled device. The input component 11 includes the enlarged input area to increase the likelihood that a user touching anywhere in the vicinity of the input component 11 will cause powering of the corresponding IC.

Returning to FIG. 1, the RFID reader 40 transmits an interrogation pulse that powers the input device 10 and causes the relevant information to be transmitted. The reader 40 includes a transceiver 41 that sends a signal to the input device 10 and reads the response. The reader 40 is further configured to transmit the received information to the device 100. The reader 40 may be a separate component from the device 100 as illustrated in FIG. 1.

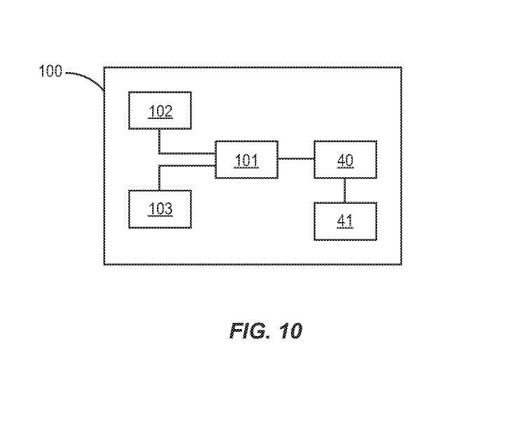

Alternatively, the reader 40 may be incorporated into the device 100 as illustrated in FIG. 10.

Device 100 may include a variety of different electronics that can act upon electrical information sent from the input device 10. Examples of devices 100 include, but are not limited to mobile phones, portable computers and similar electronic devices. The device 100 includes a processor 101 and associated memory 103 configured to control the operation of the device 100. Device 100 may further include an interface, such as a graphical user interface 102 which provides user feedback regarding active commands.

The various components of the reader 40 and/or the device 100 may be embodied in hardware and/or in software (including firmware, resident software, micro-code, etc.), including an application specific integrated circuit (ASIC).

Furthermore, one or more of the components of the present invention may take the form of a computer program product having computer usable or computer-readable program code stored on a computer usable or computer readable storage medium for use by or in connection with an instruction execution system. In the context of this document, a computer-usable or computer-readable storage medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, or a portable compact disc read-only memory (CD-ROM). Note that the computer-usable or computer-readable medium could even be paper or another suitable medium upon which the program is printed, as the program can be electronically captured via, for example, optical scanning or the paper or other medium, then compiled, interpreted, or otherwise processed in a suitable manner, if necessary, and then stored in a computer memory.

In one specific embodiment, the RFID input device 10 operates within a high frequency band designed to be read by a power field frequency of 13.56 MHz +/−7 kHz, or a range from 13.553 MHz to 13.567 MHz. The communications between the input device 10 and reader 40 may be configured to comply with ISO/IEC 18000 for passive RFID.

The system is further configured to accommodate a relatively wide tuning frequency for communication with the device 10. The relatively wide tuning frequency range is necessary due to a shift caused by various aspects of the ICs 20 used within the device 10 and/or by the use of multiple ICs 20 with a single device 10. The system is configured with the input device 10 being tuned within a frequency range of between 10.36 MHz-16.76 MHz, and preferably between 11.50 MHz-15.50 MHz.

The shift in the tuning frequency requires configuring the antenna pattern 30 to accommodate the various frequencies of the relatively wide frequency range. Antenna tuning may be achieved by controlling the physical attributes of the antenna pattern 30, such as number of coils, length and width of every coil segment, outside coil diameter, turn angles, and material selection.

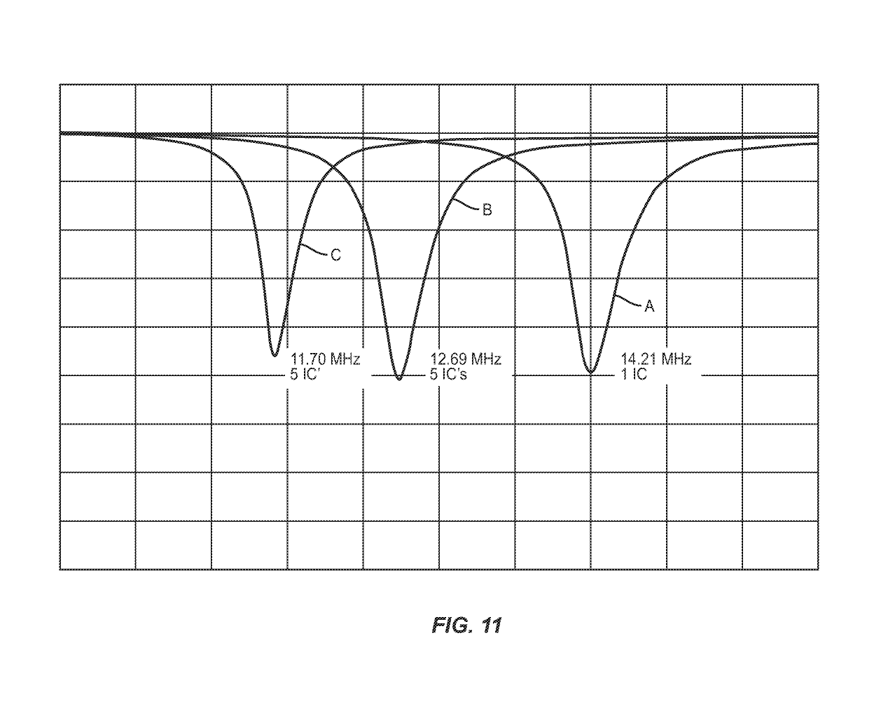

The shifts in the tuning frequency for various input devices 10 are illustrated in the three embodiments of FIG. 11. A first input device A includes an antenna pattern 30 with a single IC 20, and does not include a substrate 51. The antenna for the input device A was tuned to 14.21 MHz.

A second input device 10 was achieved by adding four (4) ICs 20 to input device A. This altered device, labeled as input device B, included a total of five ICs 20 with the same antenna pattern 30. Input device B also did not include a substrate 51. In this example, the four additional ICs 20 resulted in a tuning frequency shift of 1.52, causing the frequency to shift from 14.21 MHz to 12.69 MHz.

A third input device C was designed and included the same five (5) ICs 20 of device B with the addition of a poly-carbonate substrate 51. Input device C included a further frequency shift to 11.7 MHz. The tuning frequency shift of 2.51 MHz from 14.21 MHz to 11.7 MHz was caused by the four additional ICs 20 and the inclusion of the substrate 51. The tuning frequency shift from 12.69 MHz (with input device B) to 11.7 MHz (with input device C) was due to the inclusion of the substrate 51.

The tuning frequency shift with input devices B and C was the result of the addition of multiple ICs 20 and corresponding substrate 51 (for input device C). In a typical RFID input device 10 with a single IC 20, a shift caused by the selected substrate 51 is adjusted for in an antenna design based on known rules, and variations between measured results and predicted results is typically negligible. However, for input devices 10 with multiple ICs 20, the resultant tuning frequency shift was noticeable. This level of shift was not anticipated and required a redesign of the antenna pattern 30 in order to produce an antenna pattern 30 with the necessary tuning.

It can be considered optimal to have the final antenna pattern 30 to be tuned close to that of the powering field frequency (e.g., close to 13.56 MHz). Misalignment of the antenna tuning and powering field frequency will reduce the overall read range and efficiency. However, some misalignment of tuning can be intentional, for example to deliberately reduce the read range as required by use scenario. For example it may be desirable to tune the antenna 30 to 12.00 MHz. However, without properly designing for the tuning shift caused by additional IC's 20, the final product could be inadvertently shifted below a functional range.

As stated above, the RFID input device 10 may be used in a variety of different contexts for controlling one or more functions of the device 100. FIG. 11 illustrates the steps of a first process of using the RFID input device 10. In this embodiment, the RFID reader 40 is incorporated into the device 100 as illustrated in FIG. 10. The process is also applicable when the reader 40 is a separate unit as illustrated in FIG. 1.

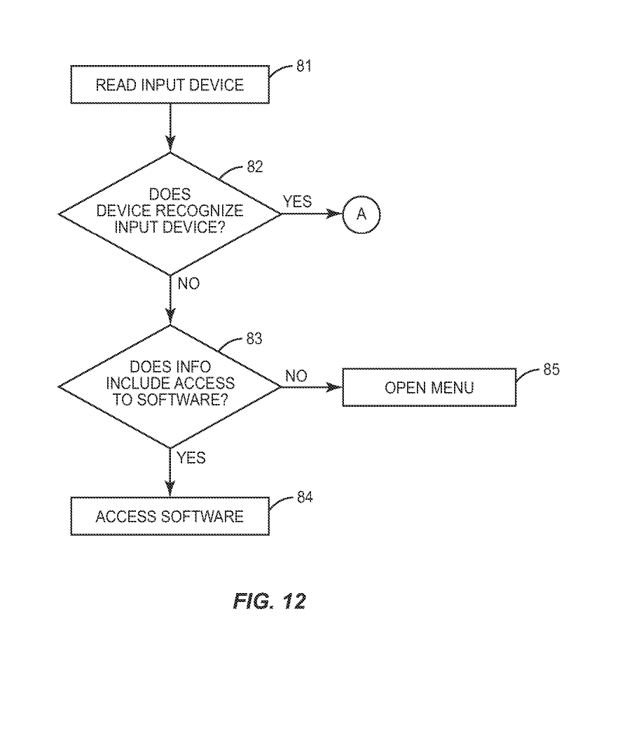

As illustrated in FIG. 12, the process begins with the reader 40 obtaining information from the RFID input device 10 (step 81). This occurs when the input device 10 is within the range of the device 100 and the input device 10 is in an active state caused by the user activating one of the input components 11. The information corresponding with the activated IC 20 is transmitted to the device 100.

The device 100 then determines whether the RFID input device 10 is recognized (step 82). This may include a determination of whether the input device 10 and device 100 are operating in accordance with a common standard. This may further include whether the device 100 includes applicable software for recognizing the input device 10.

If the device 100 does not recognize the RFID input device 10, it is then determined whether the information from the input device 10 provides a method of recognizing the RFID input device 10 (step 83). In some embodiments, the information includes a web address or other launch instructions to access software to allow recognition of the RFID input device 10. In one embodiment, the information includes instructions to access a website or open a Facebook application stored on the device 100. If there is a procedure, applicable software is accessed to provide for recognizing the RFID input device 10 and information (step 84). If there is no manner of accessing the applicable software, a generic RFID input device menu may be accessed (step 85). The menu may be stored in the device 100 and may include a listing of previously used software that may be applicable to recognize the RFID input device 10.

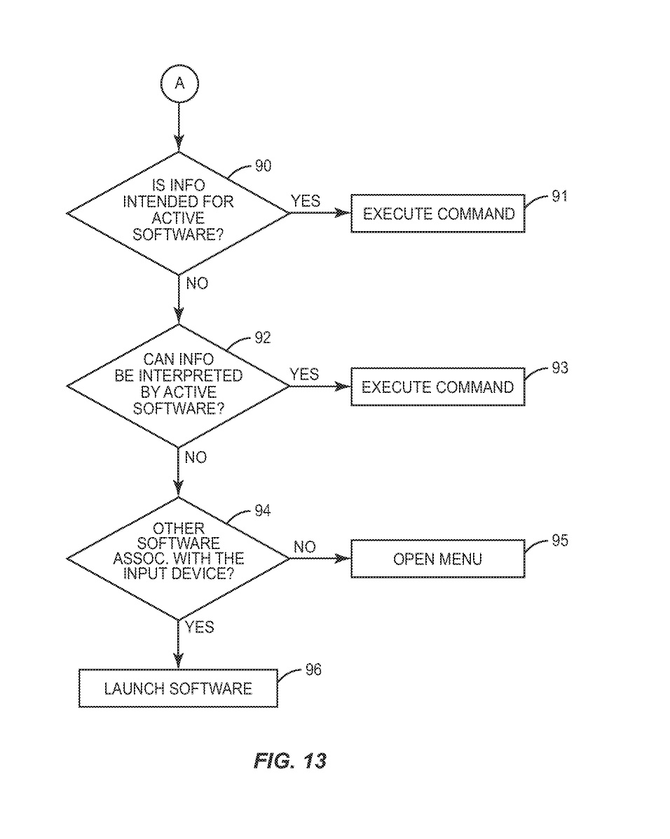

If the device 100 recognizes the RFID input device 10 at step 82, then the process continues as illustrated in FIG. 13. A determination is made whether the information from the input device 10 is intended for active software (step 90). In one embodiment, the RFID input device 10 and software are paired such that the information provided by the RFID input device 10 represent a command applicable to a specific function within the content of the software. One example includes a game application running on the device 100, wherein the input device 10 functions as a game controller. In this example, the RFID input device 10 is used in a specific context to provide commands to control a game running through the device 100. In another embodiment, the RFID input device 10 is used as a smart menu for an ordering system. A specific application running on the device 100 is operated through a command entered through the RFID input device 10 resulting in the addition of specified items in a virtual order menu. Various other contexts can also be applicable in which the software running on the device 100 requires specific controls that are available to the user through the various inputs 11 available on the RFID input device 10. When the software is running, entry of the input 11 causes the command to be executed based on the instruction of the software (step 91). This aspect is similar to various other input devices such as a mouse or keyboard.

In some instances, the RFID input device 10 is not specifically intended for use with software that is actively running on the device 100. This may include when the active software was not specifically designed to receive instructions through an RFID command. It is then determined whether the information from the input device 10 can be interpreted by the active software (step 92). If the device 100 is able to interpret the information, the information can be executed (step 93).

If the information cannot be interpreted by the active software, the device 100 determines whether there is other software associated with the RFID input device 10 (step 94). If there is no associated software, a generic RFID input device menu may be accessed (step 95). The RFID input device menu may be stored in the device 100 and may include a listing of previously used software that may be used to recognize the RFID input device 10.

If there is other software associated with the RFID input device 10, then the device 100 will launch the software (step 96). For instances where a single application is associated, the device 100 will launch the specific software.

The RFID input devices 10 may be used in a variety of different contexts. One advantage of these devices 10 is the information maintained in the one or more ICs 20 is not sent to the RFID reader 40 until the corresponding input component 11 is activated by a user. This may reduce or eliminate cross-talk between multiple RFID input devices 10, especially in and application in which multiple different devices 10 are used in a relatively small space. In one application of use, multiple different RFID input devices 10 may be used within a single periodical (e.g., magazine, book) with each device 10 applicable to a different feature, such as a different advertisement. An RFID reader 40 can be used to receive just the information of interest to the user via their selected input. Prior art RFID systems included devices that would automatically send out their information upon being powered. For multiple devices within a small space, an RFID reader may inadvertently receive multiple pieces of information from multiple different devices.

The input devices 10 of the present application overcome these issues such that multiple different input devices 10 may be used in close physical proximity. Using the periodical example of above, a first input device 10 may be placed on a first page (e.g., pg. 50) and a second input device is placed on a nearby second page (e.g., pg. 52). In use, a user may be interested in the information on the first page. The user places their RFID reader 40 at the first page and then contacts the applicable input component 11. The RFID reader 40 will just receive information from the corresponding IC 20 of the first input device 10. The second input device 10 will not transmit information because none of their input components are activated by the user. Therefore, there is no cross-talk between the input devices 10.

Terms such as “first”, “second”, and the like, are also used to describe various elements, regions, sections, etc. and are not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A method of operating an application running on an RFID enabled device based on information received from an RFID input device, the method comprising:
inductively coupling an antenna pattern of the RFID input device with an RFID reader;
receiving information at the RFID enabled device from an active input component of the RFID input device while the RFID input device is inductively coupled with the RFID reader;
recognizing the RFID input device at the RFID enabled device;
determining a command corresponding to the received information; and
operating the application running on the RFID enabled device based on the command.

2. The method of claim 1, wherein the RFID reader is incorporated with the RFID enabled device.

3. The method of claim 1, wherein determining the command corresponding to the received information and operating the application running on the RFID enabled device based on the command comprises determining that the signal is intended for the application running on the RFID enabled device.

4. The method of claim 1, wherein determining the command corresponding to the received information and operating the application running on the RFID enabled device based on the command comprises determining that the information is not intended for the application running on the RFID enabled device but can be interpreted by the application running on the RFID enabled device.

5. The method of claim 1, wherein determining the command corresponding to the received information and operating the application running on the RFID enabled device based on the command comprises determining that the information is not intended for or can be interpreted by the application running on the RFID enabled device and determining that the information can be interpreted by another application on the RFID enabled device.

6. The method of claim 1, wherein determining the command corresponding to the received information and operating the application running on the RFID enabled device based on the command comprises determining that the information is not intended for or can be interpreted by the application running on the RFID enabled device and accessing an input device menu to interpret the information.

7. The method of claim 6, wherein the input device menu comprises previously used applications that may be able to recognize the information.

8. A method of operating an RFID enabled device based on information received from an RFID input device, the method comprising:
inductively coupling an antenna pattern of the RFID input device with an RFID reader;
receiving information at the RFID enabled device from an active input component of the RFID input device while the RFID input device is inductively coupled with the RFID reader;
determining that the RFID input device is not recognized at the RFID enabled device;
determining that the information includes a recognition method of recognizing the RFID input device; and
using the recognition method to recognize the input device.

9. The method of claim 8, wherein determining that the information includes the recognition method of recognizing the RFID input device and using the recognition method to recognize the input device comprises accessing an application for a web address included in the information to recognize the RFID input device.

10. The method of claim 8, wherein determining that the information includes the recognition method of recognizing the RFID input device and using the recognition method to recognize the input device comprises opening an application stored on the RFID enabled device based on instructions included in the information.

11. The method of claim 8, wherein the RFID reader is incorporated with the RFID enabled device.

12. An RFID system comprising:
a user input device comprising:
at least one antenna pattern;
a plurality of breaks positioned along the at least one antenna pattern, each of the breaks including a gap formed between discontinuous sections of one of the at least one antenna pattern;
a plurality of integrated circuits each configured with information that is transmitted when the associated integrated circuit is powered, each of the integrated circuits being associated with a different one of the breaks;
a plurality of keys with each being associated with a different one of the breaks, each of the keys comprising a conductive material configured to extend across the gap formed between the discontinuous sections of the associated one of the breaks;
an RFID reader configured to inductively couple with the RFID input device responsive to user activation of at least one of the plurality of keys;
an RFID enabled device configured to receive the information from the user input device when the RFID input device is inductively coupled with the RFID reader, the RFID enabled device configured to execute corresponding commands in an application operating on the RFID enabled device.

13. The RFID system of claim 12, wherein the RFID reader is incorporated with the RFID enabled device.

14. The RFID system of claim 12, wherein each of the integrated circuits is associated with a different one of the antenna patterns.

15. The RFID system of claim 12, wherein the RFID input device includes a stacked configuration with a partition layer that includes one or more keyholes positioned between a first layer that includes the at least one antenna pattern and a third layer that includes the plurality of keys.

16. The RFID system of claim 15, wherein the user input device comprises a plurality of input sets each configured to send a different one of the information to the RFID enabled device, each of the input sets including one of the breaks, one of the keyholes, and one of the keys.

17. The RFID system of claim 15, wherein the third layer includes a flexible substrate that supports the plurality of keys, the flexible substrate being deformable to bring one of the plurality of keys into contact with the corresponding one of the breaks.

18. The RFID system of claim 12, wherein the RFID enabled device is configured to recognize the RFID input device based on the information received from the RFID input device.

19. The RFID system of claim 12, wherein the RFID enabled device is configured to determine that the RFID input device is not recognized at the RFID enabled device, determine that the information includes a method of recognizing the RFID input device, and use the method included with the information and recognizing the input device.

20. An RFID system comprising:
an RFID user input device comprising:
an antenna pattern;
a break positioned along the antenna pattern and including a gap formed between opposing exposed ends;
an integrated circuit associated with the break and configured with information that is transmitted when the integrated circuit is powered;
an RFID reader configured to inductively couple with the RFID input device responsive to user activation of the integrated circuit; and
an RFID enabled device configured to receive the information from the integrated circuit when the RFID input device is inductively coupled with the RFID reader;
the RFID user input device configured to transmit the information only during receipt of a user input that forms an electrical connection at the break.
